(19) United States
(12) Patent Application Publication
(10) Pub. No.: US 2024/0386313 A1
(43) Pub. Date: Nov. 21, 2024

(54) Generating an Artificial Intelligence Chatbot that Specializes in a Specific Domain

(71) Applicant: Google LLC, Mountain View, CA (US)

(72) Inventors: Zebedee Pedersen, Hove (GB); Luis De Jorge Ladrero, London (GB); Phoebe Kirkland, London (GB); Kathryn Jane Strudwick, London (GB)

(21) Appl. No.: 18/318,362

(22) Filed: May 16, 2023

(51) Int. Cl. G06N 20/00

(52) U.S. Cl. CPC G06N 20/00

(57) ABSTRACT

Methods, computing systems, and technology for generating an artificial intelligent chatbot that specializes in a specific domain are present. The system can receive, from a user device of a first user, a request for a chatbot that specializes in a specific domain. The request can include domain-specific data. Additionally, the system can select, based on the domain-specific data, a selected chatbot for the specific domain from a plurality of pretrained chatbot. The selected chatbot can be associated with a pretrained machine-learned model. Moreover, the system can access, based on the selected chatbot and the request, user-specific data. Furthermore, the system can modify, based on the user-specific data, one or more parameters of the pretrained machine-learned model to generate a customized machine-learned model. Subsequently, in response to the request, the system can deploy an expert chatbot having the customized machine-learned model to interact with the first user.

### FIELD

The present disclosure relates generally to training and deploying an artificial intelligence (AI) chatbot that specializes in a specific domain. More particularly, the present disclosure relates to training and deploying the AI chatbot in real-time using domain-specific data and user-specific data.

### BACKGROUND

An AI chatbot is a computer program designed to simulate conversation with human users using artificial intelligence techniques. It interacts with users through a chat interface, such as a messaging platform or a website, and is capable of understanding and generating natural language responses. AI chatbots utilize various technologies, including natural language processing (NLP) and machine learning to understand and interpret user inputs and generate appropriate responses. AI chatbots can be trained on large datasets of conversations to learn patterns and relationships in language, enabling them to provide relevant and contextually appropriate replies. AI chatbots find applications in various domains, including customer support, information retrieval, virtual assistants, and interactive conversational experiences.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating an artificial intelligence chatbot. The computing system can include one or more processors and one or more non-transitory computer-readable media. The computer-readable media store instructions that are executable by the one or more processors to cause the computing system to perform operations. The operations can include receiving, from a user device of a first user, a request for a chatbot that specializes in a specific domain. The request can include domain-specific data. Additionally, the operations can include selecting, based on the domain-specific data, a selected chatbot for the specific domain from a plurality of pretrained chatbot. The selected chatbot can be associated with a pretrained machine-learned model. Moreover, the operations can include accessing, based on the selected chatbot and the request, user-specific data. Furthermore, the operations can include modifying, based on the user-specific data, one or more parameters of the pretrained machine-learned model to generate a customized machine-learned model. In response to the request, the operations can include deploying an expert chatbot using the customized machine-learned model.

In some instances, the operations can include processing the user-specific data with the pretrained machine-learned model to generate a prediction. Additionally, the operations can include evaluating a loss function based on the prediction. Moreover, the one or more parameters of the pretrained machine-learned model can be modified based on the loss function.

In some instances, the operations can include receiving, from a user interface of the user device, an inference input. Additionally, the operations can include processing the inference input with the expert chatbot to generate a prediction. In some instances, the inference input can be processed with the user-specific data to generate the prediction. Moreover, the operations can include providing, on the user interface of the user device, the prediction as an output. Furthermore, the operations can include receiving a user interaction in response to providing the output on the user interface. Subsequently, the operations can include updating historical data associated with the first user based on the user interaction.

In some instances, the request includes authorization to access historical data associated with the first user. Additionally, the operations can include accessing, based on the authorization, the historical data associated with the first user. The user-specific data can include the historical data.

In some instances, the request includes login credentials for a social media account of the first user. Additionally, the operations can include accessing, using the login credentials, social media data of the first user. The user-specific data can include the social media data of the first user.

In some instances, the request can include read access to local data stored locally on the user device. Additionally, the operations can include accessing, using the read access, the local data. The user-specific data can include the local data.

In some instances, the request can include a website that is selected by the first user, and the domain-specific data can include data obtained from the website.

In some instances, the request can include an audio sharing platform that is selected by the first user, and the domain-specific data can include audio data obtained from an audio sharing platform that is associated with the domain.

In some instances, the request can include a video sharing platform that is selected by the first user, and the domain-specific data can include media data obtained from a video sharing platform that is associated with the domain.

In some instances, the request can include a social media platform that is selected by the first user, and the domain-specific data can include public data obtained from a social media platform that is associated with the domain.

In some instances, the operations can include presenting the expert chatbot on a user interface of the user device to interact with the first user.

In some instances, the operations can include sharing access of the expert chatbot with a second user based on a sharing request from the first user.

In some instances, the operations can include enabling subscription to the expert chatbot to a subscriber based on a subscription request from the subscriber.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example system for generating and customizing an expert chatbot according to example embodiments of the present disclosure.

FIG. 2 depicts an example user interface for interacting with an expert chatbot according to example embodiments of the present disclosure.

FIG. 3A and FIG. 3B depict example user interfaces for creating an expert chatbot according to example embodiments of the present disclosure.

FIG. 4A and FIG. 4B depict example user interfaces for customizing an expert chatbot according to example embodiments of the present disclosure.

FIG. 5 depicts an example user interface for incorporating new sources into the knowledge database of the expert chatbot according to example embodiments of the present disclosure.

FIG. 6A, FIG. 6B, and FIG. 6C depict a plurality of expert chatbots according to example embodiments of the present disclosure.

FIG. 7A and FIG. 7B depict example user interfaces for customizing an expert chatbot according to example embodiments of the present disclosure.

FIG. 8A and FIG. 8B depict example user interfaces for sharing an expert chatbot according to example embodiments of the present disclosure.

FIG. 9A and FIG. 9B depict example user interfaces for publishing an expert chatbot according to example embodiments of the present disclosure.

FIG. 10A and FIG. 10B depict example user interfaces for presenting a plurality of expert chatbots according to example embodiments of the present disclosure.

FIG. 11A depicts a block diagram of an example computing system according to example embodiments of the present disclosure.

FIG. 11B depicts a block diagram of an example computing device according to example embodiments of the present disclosure.

FIG. 11C depicts a block diagram of an example computing according to example embodiments of the present disclosure.

FIG. 12 depicts a flow chart diagram of an example method to generate and deploy an expert chatbot according to example embodiments of the present disclosure.

FIG. 13 depicts a flow chart diagram of an example method to interact with an expert chatbot according to example embodiments of the present disclosure.

Reference numerals that are repeated across plural figures are intended to identify the same features in various implementations.

### DETAILED DESCRIPTION

### Overview

Generally, the present disclosure is directed to training and using an expert chatbot (e.g., artificial intelligence (AI) chatbot) that specializes in a specific domain. In some instances, techniques described herein can train the expert chatbot to simulate conversation with human users using natural language processing (NLP). For example, the expert chatbot can use machine-learning (ML) models to train with domain-specific information. The expert chatbot, using NLP and ML models, can provide automated customer support, answer frequently asked questions, help users complete a task, or simply engage in casual conversation. Unlike a conventional chatbot, the expert chatbot uses ML models (e.g., neural networks) to understand and generate natural language responses. The expert chatbot can learn from interactions with users and improve its responses over time. The expert chatbot can be deployed on various platforms such as websites, messaging apps, and voice assistants.

According to some embodiments of the present invention, the expert chatbot can be trained in a specific domain based on a request from a user. For example, the expert chatbot can include an ML model (e.g., large-scale language model (LLM)) that is trained on large amounts of domain-specific data using unsupervised learning techniques. In some instances, the expert chatbot can be used for various natural language processing tasks, such as language translation, summarization, and text generation. In some instances, the ML model can be a pre-trained model (e.g., trained on a large dataset of information) and can be fine-tuned for specific domains. For example, parameters of the ML model can be adjusted based on user-specific data.

By enabling users to customize the expert chatbot based on user-specific data, the system provides users customization functionality for the expert chatbot. Users can create their own expert chatbot that is an expert in a specific domain. A specific domain can refer to a particular area or field of knowledge that is characterized by a set of concepts, objects, and/or relationships that are relevant to that domain. For example, the domain of medicine can include concepts such as diseases, symptoms, treatments, and medications. In another example, the domain of finance can include concepts such as investments, stocks, bonds, and interest rates. A user can train the expert chatbot in a specific domain by identifying the key concepts and relationships that are relevant for the domain, as well as defining the rules and constraints that govern how these concepts and relationships can be used and combined. Once the expert chatbot is generated, a user can interact with the expert chatbot. Example interactions can include the expert chatbot chatting with a user, retrieving media data for a user, selecting relevant content to present to a user, and so on.

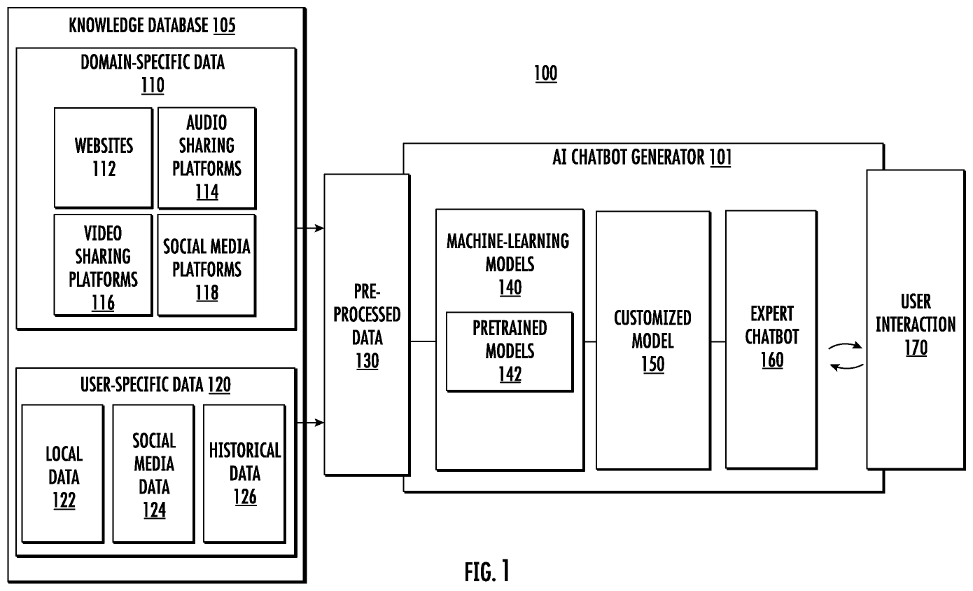

FIG. 1 depicts an example system 100 for generating and customizing an expert chatbot. The system 100 can include an artificial intelligence (AI) chatbot generator 101. The AI chatbot generator 101 can generate and train an expert chatbot based input received from a user. A user, using a user interface, can provide user input to define the domain and objectives for the expert chatbot. The user input can define the problem for the bot to solve and/or specific objectives that the user wants to achieve. The user input can include specifying the inputs, outputs, and the desired behavior of the expert chatbot. The user input can include data that can be stored in a knowledge database to train the expert chatbot. For example, the user can select domain-specific data 110 and user specific data 120 to input (e.g., transmit) into the AI chatbot generator 101. The domain-specific data 110 and the user-specific data 120 can be stored in a knowledge database for the expert chatbot. The domain-specific data 110 can include websites 112, audio sharing platforms 114 (e.g., podcasts), video sharing platforms (e.g., YouTube®), social media platform 118, or any other publicly available dataset. The user-specific data 120 can include local data 122 that is stored locally on a user device, social media data 124 of a user, historical data 126 of a user, or other private data of the user. Historical data can include past signals or past user interactions that the user had with the system 100.

According to some embodiments, the domain-specific data 110 and the user-specific data 120 can be gathered by the AI chatbot generator 101 and preprocessed. The AI chatbot generator 101, can generate preprocessed data 130 by cleaning, transforming, and formatting the domain-specific data 110 and the user-specific data 120 to make it suitable for training. The preprocessed data can be stored in the knowledge database for training the expert chatbot.

The AI chatbot generator 101 can determine and train one or more machine-learning model(s) 140 for the expert chatbot based on the preprocessed data 130. Additionally, or alternatively, the AI chatbot generator 101 can determine and train one or more machine-learning model(s) 140 for the expert chatbot based on domain-specific data 110 and user-specific data 120. For example, the AI chatbot generator 101 can determine a machine learning algorithm (e.g., supervised, unsupervised, and reinforcement learning) that is suitable for the domain and the received data. The AI chatbot generator 101 can choose an algorithm and train the expert chatbot using the preprocessed data. Training the expert chatbot can include feeding the data into the algorithm and adjusting the algorithm's parameters to optimize its performance. The training process may take some time, depending on the size of the data and the complexity of the domain. In some instances, in order to generate the expert chatbot in real-time, the AI chatbot generator 101 can select a machine-learned model from a plurality of pretrained models 142 based on the domain, the domain-specific data 110, the user-specific data 120, and/or the preprocessed data 130. Additionally, the selected machine-learned model can be modified based on the user-specific data 120 in order to customize the expert chatbot for the specific user.

The AI chatbot generator 101 can determine machine learning algorithms for an expert chatbot based on the domain, the specific use case, and the type of chatbot. In some instances, machine learning algorithms for building the expert chatbot can include, but are not limited to, Natural Language Processing (NLP) models, neural network models, reinforcement learning models, and transfer learning techniques. NLP models can focus on the interaction between computers and humans using natural language. NLP models can be used to train the expert chatbot to understand user inputs, generate responses, and carry out tasks. NLP models can include language modeling, intent classification, named entity recognition, and sentiment analysis. Neural network models (e.g., sequence-to-sequence models) can encode the input text into a fixed-length vector and decoding the vector into a response. Neural network models can be trained on large amounts of data and can generate human-like responses. Reinforcement learning models enable the expert chatbot to learn to make decisions based on rewards and punishments received from the environment. Reinforcement learning can be used to train expert chatbot to carry out tasks, such as scheduling appointments or making reservations. Transfer learning technique enables the AI chatbot generator 101 to select a pre-trained model from the plurality of pretrained models 142 as a starting point for training the customized model 150 based on the user-specific data 120. Transfer learning can be used to train chatbots on specific domains, such as healthcare or finance, by leveraging pre-trained models trained on large amounts of data. The AI chatbot generator 101 can generate an expert chatbot 160 using a combination of these machine learning models and/or algorithms to provide accurate and effective responses to user inputs.

Continuing with the transfer learning technique, the AI chatbot generator 101 can reduce the amount of training data and reduce the amount of time needed to train the customized model 150 by leveraging the knowledge learned by the selected pre-trained model for the user-selected domain. The AI chatbot generator 101 can first train a model on a large dataset, such a large corpus of text, to learn general features of the data and store the model in the plurality of pretrained models 142. The pretrained models 142 can then be used as a starting point for customizing the customized model 150 based on the user-specific data 120. The AI chatbot generator 101 can use the pre-trained models 142 learned features as a foundation and then fine-tune the customized model 150 on a user-specific data 120. For example, a pre-trained documentary recommendation model that has learned to recommend documentaries can be used as a starting point for training a customized model 150 that is tailored to a user's specific taste and or preference. The customized model 150 can leverage the pre-trained model's learned features of recommendations but would be fine-tuned on the user's preference of documentaries. By leveraging the knowledge learned by pretrained models 142, the techniques described can improve the performance of the customized model 150 while reducing the amount of training data needed.

The AI chatbot generator 101 can customize the expert chatbot based on the domain, the domain-specific data 110, the user-specific data 120, and/or the preprocessed data 130. For example, an expert chatbot can have one or more customized model(s) 150 based on the local 122, social media data 124, and historical data 126 of the user. In some instances, the AI chatbot generator 101 can evaluate, customize, and test the chatbot by evaluating the expert chatbot's performance using a separate set of data that was not used for training. Additionally, the AI chatbot generator 101 can adjust one or more parameters of the models 140, 150 based on the domain-specific data 110, the user-specific data 120, and/or the preprocessed data 130. The customized model(s) 150 can be derived from the one or more machine-learning model(s) 140 trained by the AI chatbot generator 101. Moreover, a machine-learned model can be selected from the plurality of machine-learned models 142 and customized based on domain-specific data 110 and user-specific data 120 to generate customized models 150.

The AI chatbot generator 101 can generate the expert chatbot 160 having customized models 150. The AI chatbot generator 101 can deploy expert chatbot 160 to communicate with users. Additionally, the AI chatbot generator 101 can update the chatbot based on user interaction 170. The AI chatbot generator 101 can continuously monitor the expert chatbot's performance and update one or more parameters of the models 140, 150. 0. The AI chatbot generator 101 can collect user feedback, analyze the data, and make adjustments to the expert chatbot's algorithms and parameters as needed.

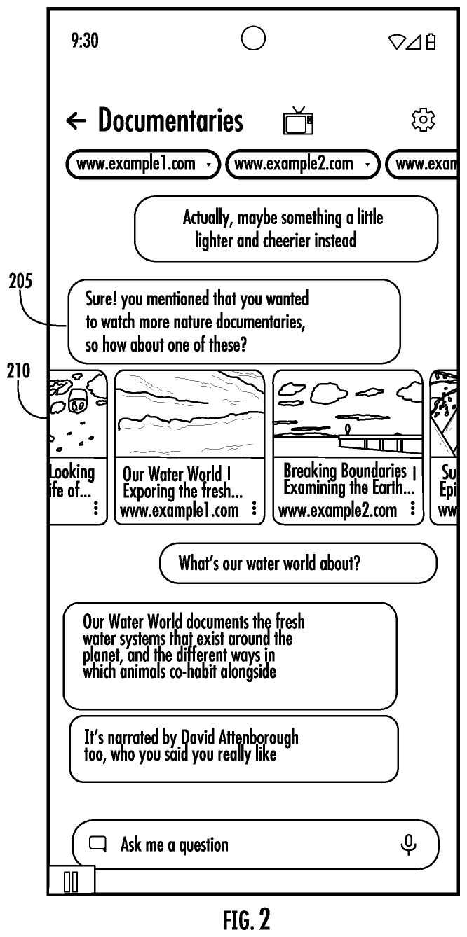

FIG. 2 depicts an example user interface 200 for interacting with an expert chatbot according to example embodiments of the present disclosure. As previously mentioned, expert chatbots can be individual AI chatbot with a specific area of expertise. The expert chatbot can generate and present a search result (e.g., answer) in a chat box 205 to respond to a query (e.g., question) from a user. Additionally, the expert chatbot can retrieve and present media data 210 based on a query from the user. In this example, the expert chatbot can be an expert in documentaries, and can determine relevant content (e.g., media data 210) to present on the user interface. The relevant content can be determined using an ML model that is trained using domain-specific data. In this example, the domain-specific data can include information associated with documentaries and historical data of the user (e.g., past preferences of documentaries by the user).

In this example, the expert chatbot can have a knowledge database of documentaries. In some instances, the machine-learned model can be pre-trained to documentaries based on a knowledge database of domain-specific data associated with documentaries. The knowledge database can further include user-specific information that is received or derived from the user. For example, the user can provide a personal preference by selecting a first web resource and a second web resource to include in the knowledge database. Additionally, the knowledge database can include private data associated with the user.

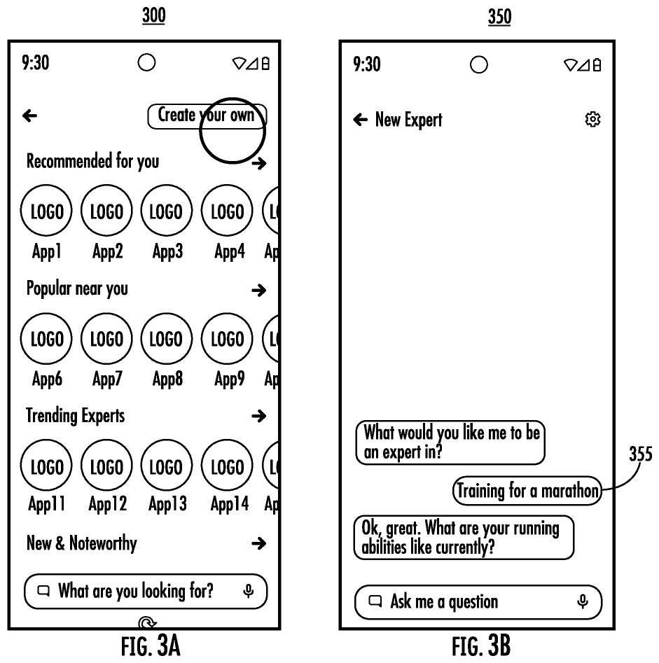

FIGS. 3A-B depict example user interfaces for creating an expert chatbot according to example embodiments of the present disclosure. As illustrated in the user interface 300 in FIG. 3A, the system can suggest a plurality of experts chatbot for a user to select. Additionally, the user can provide user-specific information for additional context.

As illustrated in the user interface 350 in FIG. 3B, the system can present a dialog interface for the user to customize the expert chatbot. The user can provide user-specific information, such as in this example input 355, the user has inputted “training for a marathon.”

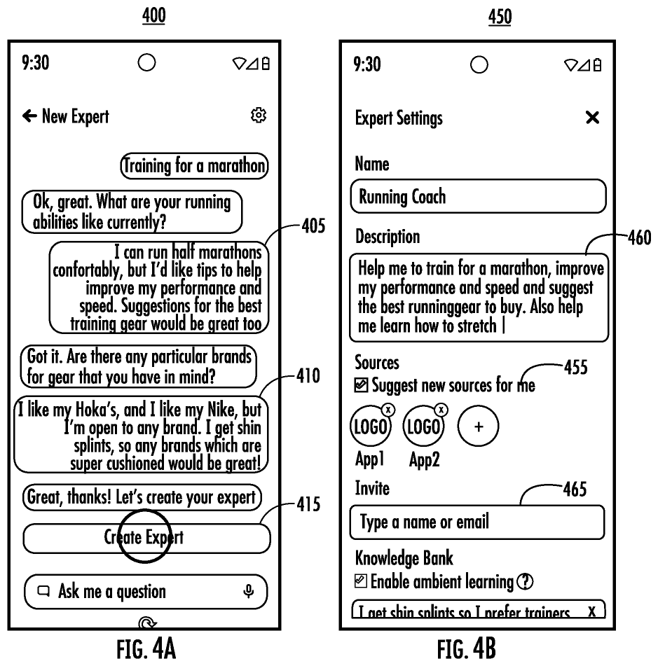

FIGS. 4A-B depict example user interfaces for customizing an expert chatbot according to example embodiments of the present disclosure. As illustrated in the user interface 400 in FIG. 4A, the expert chatbot can be customized based on the user-specific information. A user can interact with the dialog interface 400 (e.g., user interface) to provide user-specific information 405, 410. The user-specific information can provide additional context to the chatbot about user preferences, user goals, user intent, user knowledge, and so on. Once the user-specific information is provided, the user can select the “create expert” button 415 to configure the expert chatbot based on this user-specific information that is received from the user.

As illustrated in the user interface 450 in FIG. 4B, the expert chatbot can be further customized based on additional sources. In some instances, a user can initiate the creation of the expert chatbot using a dialog interface 400 in FIG. 4A, and subsequently the user can further customize the expert chatbot using the interface 450 in FIG. 4B. The system, based on an analysis of the user-specific information 405, 410, can recommend additional sources 455 and present the additional sources 455 on the user interface 450. The user can select the additional sources to include in the knowledge database of the expert chatbot. Additionally, the user interface 450 enables a user to provide additional information about the expert chatbot, such as a description 460, an invitation 465 for other users to customize the expert chatbot, and other settings related to the expert chatbot.

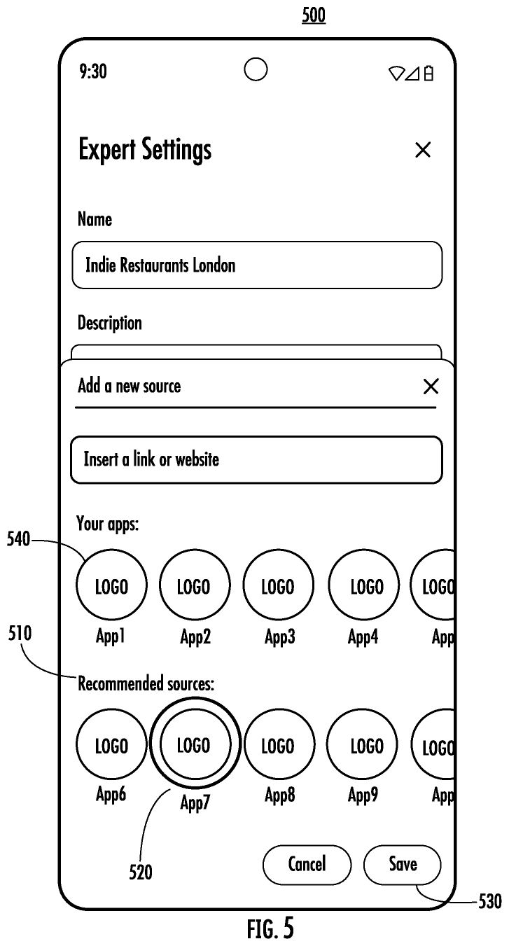

FIG. 5 depicts an example user interface 500 for incorporating new sources into the knowledge database of the expert chatbot according to example embodiments of the present disclosure. In this example, the user is creating an expert chatbot for restaurants. The system, using a machine-learned model, can determine sources to recommend to the user. The system can present the sources in the recommended sources section 510 of the user interface 500. In response to being presented with the recommended sources, the user can select a recommended source 520 and click on a button 530 to update the knowledge database of the expert chatbot to include the recommended source 520. Additionally, the expert chatbot can be further customized by receiving user-specific data. For example, a user can provide access to user-specific data that is stored in an installed application 540 (e.g., mobile app) already installed in the mobile device of the user. By enabling the expert chatbot access to user-specific data obtained from the installed application 540, the expert chatbot can provide better results and answers to a user query.

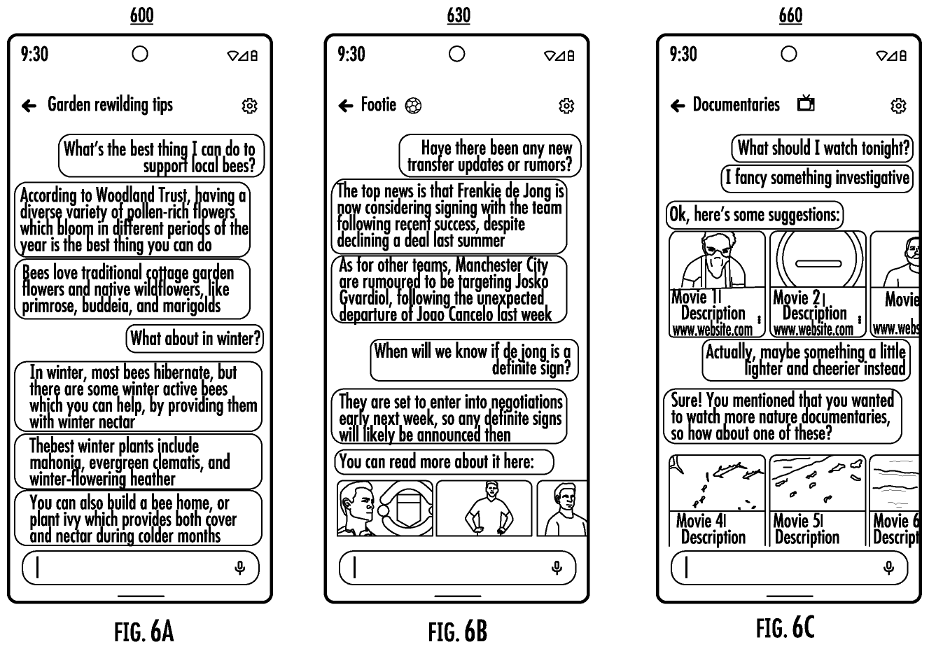

FIGS. 6A-C depict a plurality of expert chatbots according to example embodiments of the present disclosure. As illustrated in the chat interaction 600 in FIG. 6A, the expert chatbot can specialize in gardening. In the chat interaction 600, the expert chatbot can provide information about gardening and provide tutorials about gardening. Alternatively, the expert chatbot can specialize in football as illustrated in the chat interaction 630 in FIG. 6B. In the chat interaction 630, the expert chatbot can provide the user information about current events. The current events can be tailored to the user's preferences (e.g., favorite sports team, topic, interest). In yet another embodiment, the expert chatbot can specialize in documentaries as illustrated in the chat interaction 660 in FIG. 6C. In the chat interaction 660, the expert chatbot can provide recommendations based on past interactions with the user.

The chat interactions 600, 630, 660 illustrate that the expert chatbot can be customized by a user in multiple ways. A user can customize each expert chatbot by selecting the expert chatbot's primary sources from public and personal data. Public sources can include websites, mobile applications, online audio sharing platforms (e.g., podcasts), online video sharing platforms (e.g., YouTube®), social media platforms. Private sources can include a user's account at a specific resource (e.g., website, publications, online sharing platform, or social media platform) Additionally, private sources can include user-specific data stored only on the mobile device or computing system of the user. In some instances, private sources can include non-public databases that the user has access to. For example, the user can provide login credentials to access the non-public database. The knowledge database can include the primary sources selected by a user during the creation or customization of the expert chatbot. Moreover, the system can present a plurality of tone and/or voices, and the user can select a preferred tone and/or voice for the expert chatbot.

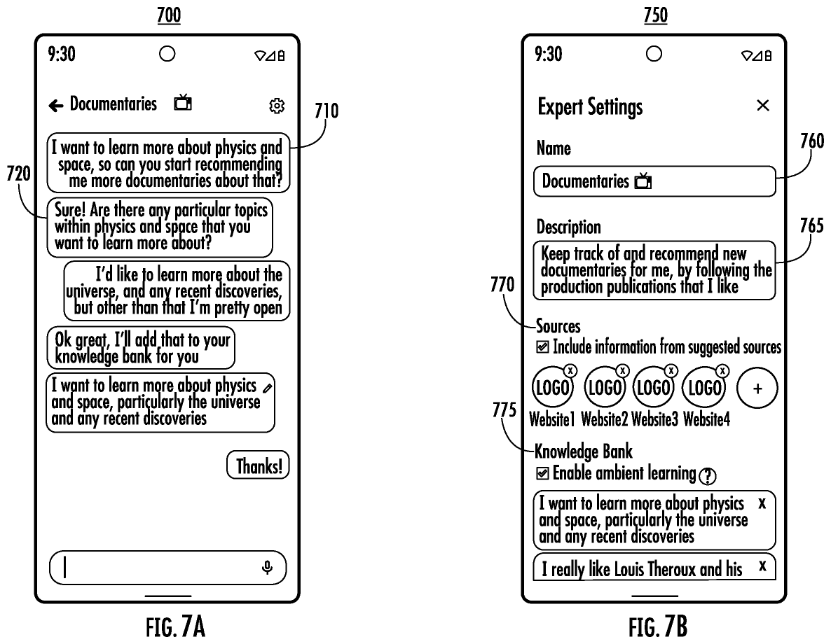

FIGS. 7A-B depict example user interfaces for customizing an expert chatbot according to example embodiments of the present disclosure. For example, a user can coach the expert chatbot and share information with the expert chatbot in order to enable the expert chatbot to perform better. In the chat interface 700 in FIG. 7A, the system can receive a request 710 for an expert chatbot that provides recommendations in a specific field (e.g., physics and space). In response to the request 710, the expert chatbot can initiate a conversation 720 to obtain further details about the request. Using the chat interface, the user can coach the expert chatbot and provide information to assist the expert chatbot to perform better (e.g., provide more accurate answers and recommendations). At any time, the user can provide additional information to the expert chatbot using the chatbot interface 700. Additionally, the information provided by the user via the chatbot interface 700 can be automatically inserted, by the system, into fields of the settings interface 750 of the expert chatbot in FIG. 7B. The setting interface 750 can include a title field 755, name field 760, a description field 765, a source field 770, a knowledge bank field 775, and other fields that can be associated with customizing the expert chatbot. The knowledge bank field 775 can include user-specific information that remains private and stored securely in the knowledge bank database.

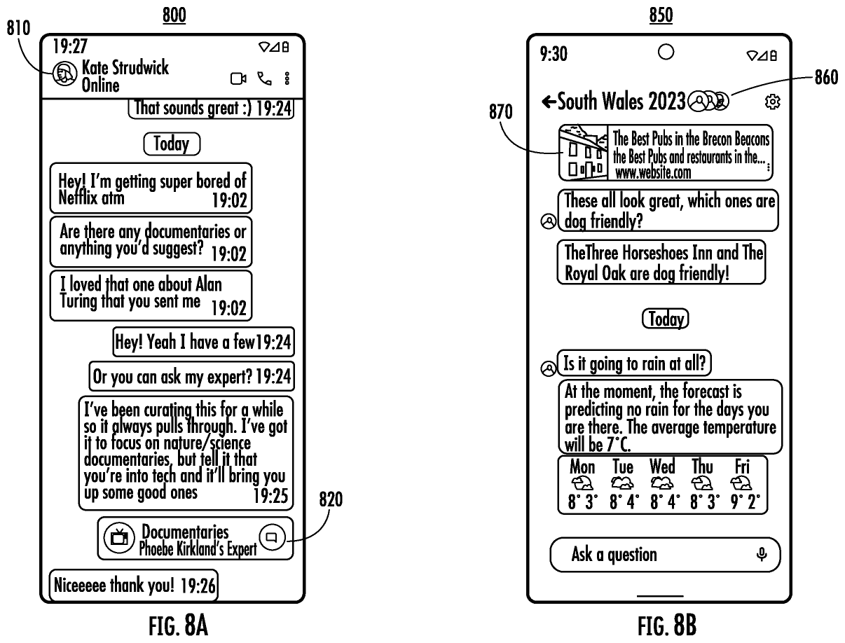

FIGS. 8A-B depict example user interfaces for sharing an expert chatbot according to example embodiments of the present disclosure. The expert chatbot can be individual entities, and therefore easily shareable by the user that created the expert chatbot. For example, in the user interface 800 illustrated FIG. 8A, a first user can share a link 820 to an expert chatbot to a second user 810 over a messaging application. In the user interface 850 illustrated in FIG. 8B, a user can share an expert chatbot 870 to a group of individuals 860 who are planning a trip together. In this example, the expert chatbot 870 can be a chatbot that specializes in travel and holiday planning.

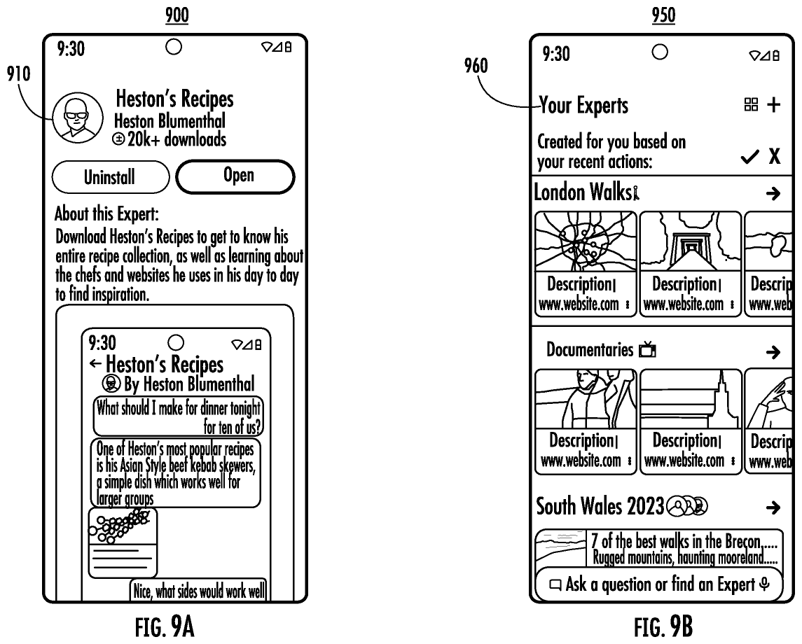

FIGS. 9A-B depict example user interfaces for publishing an expert chatbot according to example embodiments of the present disclosure. For example, in the user interface 900 illustrated FIG. 9A, a user can download an expert chatbot 910 from an app store. In some instances, the expert chatbot 910 can be a premium subscription for a fee, where the entity that has created the expert chatbot 910 can be compensated for other users using the expert chatbot 910. In the user interface 950 illustrated in FIG. 9B, the system can create an expert chatbot 960 based on historical data 126 (e.g., recent actions). For example, the system can dynamically suggest an expert chatbot 960 based on a user's context and interests.

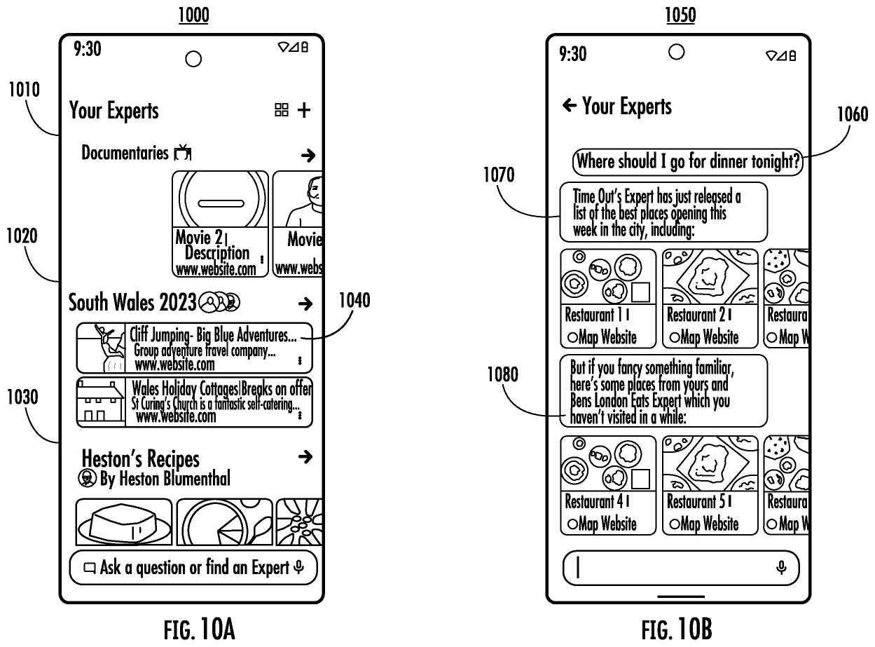

FIGS. 10A-B depict example user interfaces for presenting a plurality of expert chatbots according to example embodiments of the present disclosure. FIG. 10A depicts an example user interface 1000 that organizes and presents a first expert chatbot 1010, a second expert chatbot 1020, and a third expert chatbot 1030 on a home page of the user device of the user. Additionally, the user interface 1000 can include a home feed that also displays updates 1040 for each expert chatbot. FIG. 10B illustrates an example user interface 1050 that enables a user to ask a question 1060 to multiple expert chatbot at the same time. The user can receive a plurality of answers from the different expert chatbots. The plurality of answers can include a first answer 1070 from a first expert chatbot and a second answer 1080 from a second expert chatbot.

With reference now to the Figures, example embodiments of the present disclosure will be discussed in further detail.

### Example Devices and Systems

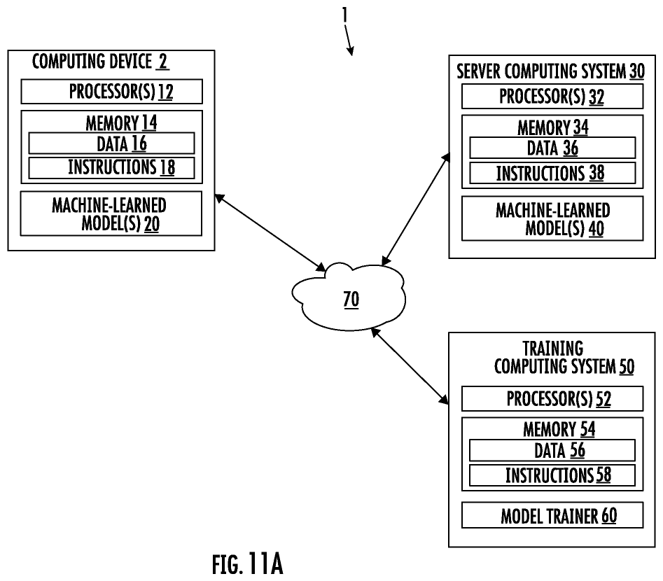

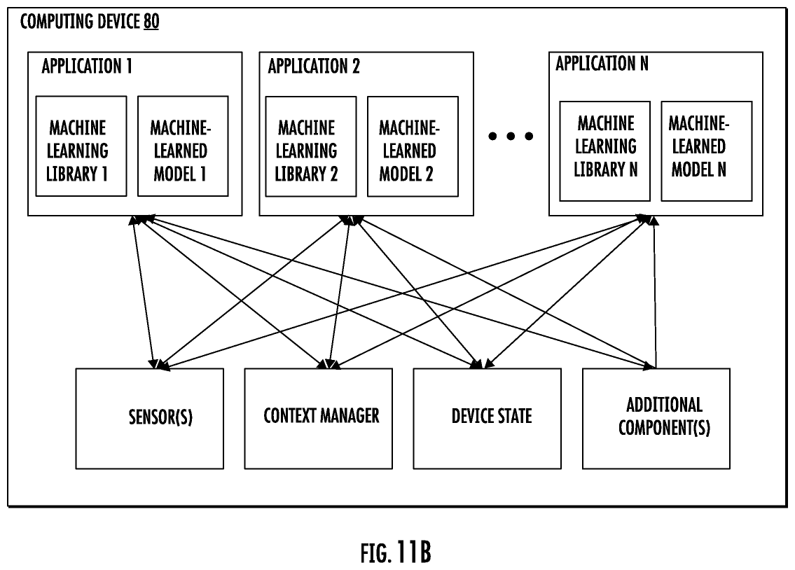

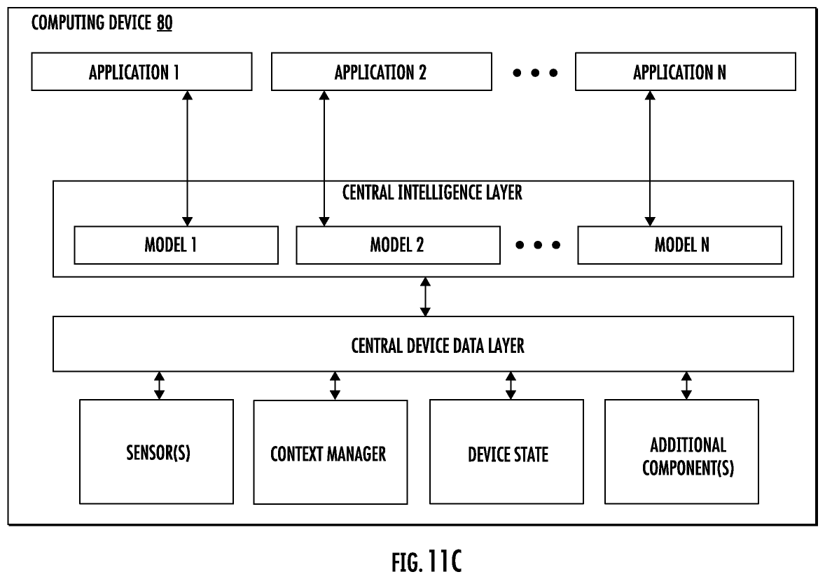

FIG. 11A depicts a block diagram of an example computing system 1 that can perform according to example embodiments of the present disclosure. The system 1 includes a computing device 2, a server computing system 30, and a training computing system 50 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller, etc.) and can be one processor or a plurality of processors that are operatively connected. The memory 14 can include one or more non-transitory computer-readable storage media, such as RAM, ROM, EEPROM, EPROM, flash memory devices, magnetic disks, etc., and combinations thereof. The memory 14 can store data 16 and instructions 18 which are executed by the processor 12 to cause the user computing device 2 to perform operations (e.g., to perform operations implementing input data structures and self-consistency output sampling according to example embodiments of the present disclosure, etc.).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine-learned model 20.

Additionally, or alternatively, one or more machine-learned models 40 can be included in or otherwise stored and implemented by the server computing system 30 that communicates with the computing device 2 according to a client-server relationship.

Machine-learned model(s) 20 and 40 can include any one or more of the machine-learned models described herein, including the machine-learned asset generation pipeline and any of the component models therein.

The machine-learned models described in this specification may be used in a variety of tasks, applications, and/or use cases. Although described throughout with respect to example implementations for applications in medical domains, it is to be understood that the techniques described herein may be used for other tasks in various technological fields.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some embodiments, the machine-learned models 40 can be implemented by the server computing system 30 as a portion of a web service (e.g., remote machine-learned model hosting service, such as an online interface for performing machine-learned model operations over a network on remote servers 30). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed, etc.) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing device 2 is a user endpoint associated with a user account of a campaign generation system. The campaign generation system can operate on the server computing system 30.

The server computing system 30 can include one or more processors 32 and a memory 34. The one or more processors 32 can be any suitable processing device (e.g., a processor core, a microprocessor, an ASIC, an FPGA, a controller, a microcontroller, etc.) and can be one processor or a plurality of processors that are operatively connected. The memory 34 can include one or more non-transitory computer-readable storage media, such as RAM, ROM, EEPROM, EPROM, flash memory devices, magnetic disks, etc., and combinations thereof. The memory 34 can store data 36 and instructions 38 which are executed by the processor 32 to cause the server computing system 30 to perform operations.

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 2 or the server computing system 30 can train example embodiments of a machine-learned model (e.g., including models 20 or 40) using a training pipeline (e.g., an unsupervised pipeline, a semi-supervised pipeline, etc.). In some embodiments, the computing device 2 or the server computing system 30 can train example embodiments of a machine-learned model (e.g., including models 20 or 40) using a pre-training pipeline by interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller, etc.) and can be one processor or a plurality of processors that are operatively connected. The memory 54 can include one or more non-transitory computer-readable storage media, such as RAM, ROM, EEPROM, EPROM, flash memory devices, magnetic disks, etc., and combinations thereof. The memory 54 can store data 56 and instructions 58 which are executed by the processor 52 to cause the training computing system 50 to perform operations (e.g., to perform operations implementing input data structures and self-consistency output sampling according to example embodiments of the present disclosure, etc.). In some implementations, the training computing system 50 includes or is otherwise implemented by one or more server computing devices.

The model trainer 60 can include a training pipeline for training machine-learned models using various objectives. Parameters of the image-processing model(s) can be trained, in some embodiments, using various training or learning techniques, such as, for example, backwards propagation of errors. For example, an objective or loss can be back propagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts, etc.) to improve the generalization capability of the models being trained.

The model trainer 60 can train one or more machine-learned models 20 or 40 using training data (e.g., data 56). The training data can include, for example, historical performance data, past user interactions, and/or past campaigns.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 11A illustrates one example computing system that can be used to implement the present disclosure. Other computing systems can be used as well. For example, in some implementations, the computing device 2 can include the model trainer 60. In some implementations, the computing device 2 can implement the model trainer 60 to personalize the model(s) based on device-specific data.

FIG. 11B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 11C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central device data layer. The central device data layer can be a centralized repository of data for the computing device 80. As illustrated in FIG. 11C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

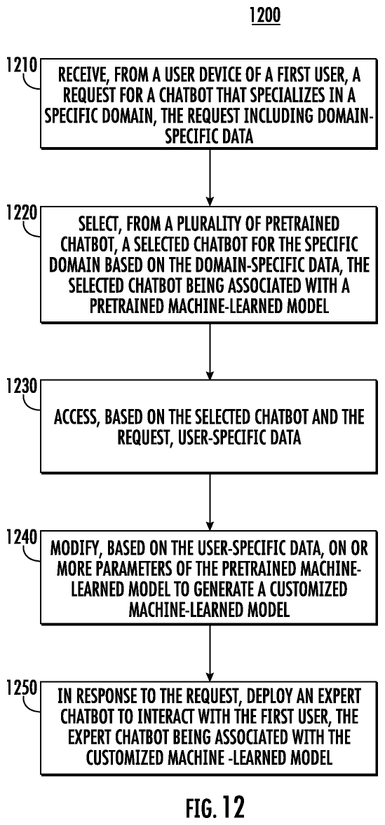

FIG. 12 depicts a flow chart diagram of an example method to perform according to example embodiments of the present disclosure. Although FIG. 12 depicts steps performed in a particular order for purposes of illustration and discussion, the methods of the present disclosure are not limited to the particularly illustrated order or arrangement. The various steps of the method 1200 can be omitted, rearranged, combined, and/or adapted in various ways without deviating from the scope of the present disclosure.

At 1210, a computing system (e.g., AI chatbot generator 101) can receive, from a user device of a first user, a request for a chatbot that specializes in a specific domain. The request can include domain-specific data (e.g., domain-specific data 110).

In some instances, the request can include a website 112 that is selected by the first user, and the domain-specific data can include data obtained from the website.

In some instances, the request can include an audio sharing platform 114 that is selected by the first user, and the domain-specific data can include audio data obtained from an audio sharing platform that is associated with the domain.

In some instances, the request can include a video sharing platform 116 that is selected by the first user, and the domain-specific data can include media data obtained from a video sharing platform that is associated with the domain.

In some instances, the request can include a social media platform 118 that is selected by the first user, and the domain-specific data can include public data obtained from a social media platform that is associated with the domain.

At 1220, the computing system can select, based on the domain-specific data (e.g., domain-specific data 110), a selected chatbot for the specific domain, from a plurality of pretrained chatbot. The selected chatbot can be associated with a pretrained machine-learned model (e.g., pretrained models 142).

At 1230, the computing system can access, based on the selected chatbot and the request, user-specific data (e.g., user-specific data 120).

In some instances, the domain-specific data 110 and/or the user specific data 120 can be preprocessed (e.g., preprocessed data 130) prior to being inputted into the computing system (e.g., AI chatbot generator 101).

In some instances, the request includes authorization to access historical data (e.g., historical data 126) associated with the first user. Additionally, the operations can include accessing, based on the authorization, the historical data associated with the first user. The user-specific data (e.g., user-specific data 120) can include the historical data.

In some instances, the request includes login credentials for a social media account of the first user. Additionally, the operations can include accessing, using the login credentials, social media data (e.g., social media data 124) of the first user. The user-specific data (e.g., user-specific data 120) can include the social media data of the first user.

In some instances, the request can include read access to local data stored locally on the user device. Additionally, the operations can include accessing, using the read access, the local data (e.g., local data 122). The user-specific data (e.g., user-specific data 120) can include the local data.

In some instances, the pretrained machine-learned model (e.g., pretrained model 142) of the selected chatbot includes a first variable, and the user-specific data can be accessed based on the first variable. For example, the first variable can be an attribute (e.g., age, location, language, profession, hobby, interest) of a user, and the user-specific data that is accessed is based on the attribute of the user.

At 1240, the computing system can modify, based on the user-specific data, one or more parameters of the pretrained machine-learned model to generate a customized machine-learned model (e.g., customized model 150).

In some instances, the pretrained machine-learned model is updated by modifying one or more of the parameters of the model. To modify a parameter of the pretrained model, the system can access the model's architecture and update a specific parameter. For example, the system can load the pretrained model weights and architecture into a programming environment using an appropriate function provided by a deep learning framework. The system may receive access rights and/or authorization to modify a parameter of the model. Once the pretrained model is loaded, the system can access its parameters. The model's parameters are typically stored in its layers or modules. The system can identify the specific parameter to modify based on the user-specific data 120. Subsequently, the system can update a value of the specific parameter by assigning a new value to the parameter or using a specific function provided by the framework for the parameter update. The new value can be based on the user-specific data 120. Furthermore, the system can store the pretrained model with the updated parameter as the customized machine-learned model 150.

Additionally, or alternatively, the one or more parameters can be one or more prompts that the system provides the pretrained machine-learned model to generate a customized machine-learned model. The system can utilize prompt engineering techniques to update the one or more parameters of the pretrained machine-learned model. The one or more prompts can be based on the user-specific data 120 (e.g., local data 122, social media data 124, historical data 126). For example, the system can automatically provide a prompt to the pretrained machine-learned model about attributes of the user (e.g., user is based out of London, prefers Mediterranean cuisine, follows the medical industry per their social media, follows a first expert in healthcare per their social media, educational background, work background). The pretrained model can utilize the provided prompts to generate a customized machine-learned model to provide custom answers to the user based on the attributes of the user. For example, the pretrained model can include parameters in the model that can be prefilled with the attributes of the user that are automatically provided to the model by the system.

Prompt engineering techniques refers to the process of designing or formulating effective prompts for NLP models by providing instructions or queries that guide the behavior of the pretrained machine-learned model to generate desired outputs. The system can automatically communicate a user's intent to obtain accurate and relevant responses. By providing a well-designed prompt, the system can elicit the desired information or perform specific tasks using the model. For example, the system can provide prompts that specify a desired format or structure of the response (e.g., asking the model to list steps for a process, provide pros and cons, or summarize a given text). Additionally, the system can provide relevant context or information that influences the model's generation (e.g., by incorporating specific keywords or phrases to guide the response). Moreover, the system can provide system-related instructions to enhance the user experience (e.g., asking the model to provide a response that a particular personality would give). Furthermore, the system can provide existing prompt templates or approaches that have been proven effective for similar tasks or domains by leveraging prior knowledge and experience to engineer effective prompts.

In some instances, the pretrained machine-learned model of the selected chatbot can include a first variable. The user-specific data that is accessed at 1230 can be based on the first variable. For example, the first variable can be an attribute of the first user. The attribute is a location, an age, a language, a profession, a hobby, or an interest associated with the first user. Additionally, the one or more parameters of the pretrained machine-learned model modified at 1240 can be based on the first attribute to generate the customized machine-learned model.

In some instances, the operations can include processing the user-specific data with the pretrained machine-learned model to generate a prediction. Additionally, the operations can include evaluating a loss function based on the prediction. Moreover, the one or more parameters of the pretrained machine-learned model can be modified based on the loss function.

In response to the request, at 1250, the computing system can deploy an expert chatbot (e.g., expert chatbot 160) having the customized machine-learned model (e.g., customized model 150).

In some instances, the operations can include receiving, from a user interface of the user device, an inference input. Additionally, the operations can include processing the inference input with the expert chatbot to generate a prediction. In some instances, the inference input can be processed with the user-specific data to generate the prediction. Moreover, the operations can include providing, on the user interface of the user device, the prediction as an output. Furthermore, the operations can include receiving a user interaction (e.g., user interaction 170) in response to providing the output on the user interface. Subsequently, the operations can include updating historical data associated with the first user based on the user interaction.

In some instances, the operations can include presenting the expert chatbot on a user interface of the user device to interact with the first user.

In some instances, the operations can include sharing access of the expert chatbot with a second user based on a sharing request from the first user.

In some instances, the operations can include enabling subscription to the expert chatbot to a subscriber based on a subscription request from the subscriber.

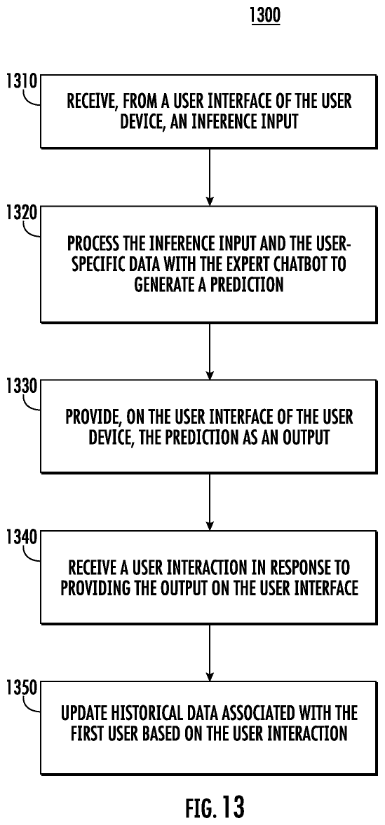

FIG. 13 depicts a flow chart diagram of an example method to perform according to example embodiments of the present disclosure. Although FIG. 13 depicts steps performed in a particular order for purposes of illustration and discussion, the methods of the present disclosure are not limited to the particularly illustrated order or arrangement. The various steps of the method 1300 can be omitted, rearranged, combined, and/or adapted in various ways without deviating from the scope of the present disclosure.

At 1310, a computing system can receive, from a user interface of the user device, an inference input.

At 1320, the computing system can process the inference input and the user-specific data with the expert chatbot to generate a prediction. As described in FIG. 12, the user-specific data can be accessed at 1230 and the expert chatbot can be deployed at 1250. Alternatively, the computing system can process only the inference input (e.g., without the user-specific data) with the expert chatbot to generate a prediction.

At 1330, the computing system can provide, on the user interface of the user device, the prediction as an output. As described in FIG. 12, the computing system can receive a request from the user device of the first user, and in response to this request, provide the output.

At 1340, the computing system can receive a user interaction (e.g., user interaction 170) in response to providing the output on the user interface.

At 1350, the computing system can update historical data (e.g., historical data 126) associated with the first user based on the user interaction.

In some instances, wherein the request received at 1210 can include authorization to access historical data associated with the first user. Therefore, the operations in method 1200 can further include accessing, based on the authorization, the historical data associated with the first user, and the user-specific data (e.g., user-specific data 120) includes the historical data.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system, comprising:
one or more processors; and
one or more non-transitory computer-readable media storing instructions that are executable by the one or more processors to cause the computing system to perform operations, the operations comprising:
receiving, from a user device of a first user, a request for a chatbot that specializes in a specific domain, the request including domain-specific data;
selecting, from a plurality of pretrained chatbot, a selected chatbot for the specific domain based on the domain-specific data, the selected chatbot being associated with a pretrained machine-learned model;
accessing, based on the selected chatbot and the request, user-specific data;
modifying, based on the user-specific data, one or more parameters of the pretrained machine-learned model to generate a customized machine-learned model; and
in response to the request, deploying an expert chatbot having the customized machine-learned model.

2. The computing system of claim 1, wherein the operations further comprise:
processing the user-specific data with the pretrained machine-learned model to generate a prediction;
evaluating a loss function based on the prediction; and
wherein the one or more parameters of the pretrained machine-learned model is modified based on the loss function.

3. The computing system of claim 1, wherein the operations further comprise:
receiving, from a user interface of the user device, an inference input;
processing the inference input with the expert chatbot to generate a prediction; and
providing, on the user interface of the user device, the prediction as an output.

4. The computing system of claim 3, wherein the operations comprise:
receiving a user interaction in response to providing the output on the user interface; and
updating historical data associated with the first user based on the user interaction.

5. The computing system of claim 3, wherein the inference input is processed with the user-specific data to generate the prediction.

6. The computing system of claim 3, wherein the operations further comprise:
processing the inference input with a second expert chatbot to generate a second prediction, and
providing, on the user interface of the user device, the second prediction as a second output, and wherein the first output and the second output are presented concurrently on the user interface.

7. The computing system of claim 1, wherein the request includes authorization to access to historical data associated with the first user, the operations comprise:
accessing, based on the authorization, the historical data associated with the first user, and
wherein the user-specific data includes the historical data.

8. The computing system of claim 1, wherein the request includes login credentials for a social media account of the first user, the operations comprise:
accessing, using the login credentials, social media data of the first user, and
wherein the user-specific data includes the social media data of the first user.

9. The computing system of claim 1, wherein the request includes read access to local data stored locally on the user device, the operations comprise:
accessing, using the read access, the local data, and
wherein the user-specific data includes the local data.

10. The computing system of claim 1, wherein the request includes a website that is selected by the first user, and wherein the domain-specific data includes data obtained from the website.

11. The computing system of claim 1, wherein the request includes an audio sharing platform that is selected by the first user, and wherein the domain-specific data includes audio data obtained from an audio sharing platform that is associated with the domain.

12. The computing system of claim 1, wherein the request includes a video sharing platform that is selected by the first user, and wherein the domain-specific data includes media data obtained from a video sharing platform that is associated with the domain.

13. The computing system of claim 1, wherein the request includes a social media platform that is selected by the first user, and wherein the domain-specific data includes public data obtained from a social media platform that is associated with the domain.

14. The computing system of claim 1, wherein the operations further comprise:
sharing access of the expert chatbot with a second user based on a sharing request from the first user; and
enabling subscription to the expert chatbot to a subscriber based on a subscription request from the subscriber.

15. The computing system of claim 1, wherein the pretrained machine-learned model of the selected chatbot includes a first variable, and wherein the user-specific data accessed is based on the first variable.

16. The computing system of claim 15, the operations comprising:
providing the user-specific data that is accessed based on the first variable to the selected chatbot, wherein the provided user-specific data modifies the one or more parameters of the pretrained machine-learned model to generate the customized machine-learned model.

17. The computing system of claim 15, wherein the first variable is an attribute of the first user, and wherein the attribute is a location, an age, or a language associated with the first user.

18. The computing system of claim 15, wherein the one or more parameters of the pretrained machine-learned model is modified based on the first attribute to generate the customized machine-learned model.

19. A computer-implemented method to deploy an expert chatbot, the method comprising:
receiving, from a user device of a first user, a request for a chatbot that specializes in a specific domain, the request including domain-specific data;
selecting, from a plurality of pretrained chatbot, a selected chatbot for the specific domain based on the domain-specific data, the selected chatbot being associated with a pretrained machine-learned model;
accessing, based on the selected chatbot and the request, user-specific data;
modifying, based on the user-specific data, one or more parameters of the pretrained machine-learned model to generate a customized machine-learned model; and
in response to the request, deploying the expert chatbot having the customized machine-learned model.

20. One or more non-transitory computer-readable media that store instructions that, when executed by one or more processors, cause the one or more processors to perform operations, the operations comprising:
receiving, from a user device of a first user, a request for a chatbot that specializes in a specific domain, the request including domain-specific data;
selecting, from a plurality of pretrained chatbot, a selected chatbot for the specific domain based on the domain-specific data, the selected chatbot being associated with a pretrained machine-learned model;
accessing, based on the selected chatbot and the request, user-specific data;
modifying, based on the user-specific data, one or more parameters of the pretrained machine-learned model to generate a customized machine-learned model; and
in response to the request, deploying an expert chatbot having the customized machine-learned model.
